(19) United States
(12) Patent Application Publication
(10) Pub. No.: US 2019/0311538 A1
(43) Pub. Date: Oct. 10, 2019

(54) METHOD AND SYSTEM FOR MAPPING OF PRODUCTS TO ARCHITECTURAL DESIGN IN REAL TIME

(71) Applicant: BuildNext Construction Solutions, Kazhakkootam (IN)

(72) Inventors: Gopikrishnan Vadakkeveedu, Palakkad (IN); Finaz Naha Kizhakiniyakath, Malappuram (IN); Dileep Pallasana Gopalakrishnan, Kozhikode (IN); Nithin Jose, Kottayam (IN); Romy Rosamma Michael, Thiruvananthapuram (IN)

(21) Appl. No.: 16/033,148

(22) Filed: Jul. 11, 2018

(30) Foreign Application Priority Data
Apr. 9, 2018 (IN) 201841013500

(51) Int. Cl. G06T 19/00; G06T 17/05

(52) U.S. Cl. CPC G06T 19/003; G06T 2200/08; G06T 2200/04; G06T 17/05

(57) ABSTRACT

The present disclosure provides a method and system for providing real-time mapping of products to an architectural design in a virtual reality representation. The system collects a first set of data associated with one or more facility material products. Further, the system receives a second set of data associated with a facility. Also, the system maps the first set of data with the second set of data. In addition, the system creates the virtual reality representation of the facility based on the first set of data, the second set of data and mapping of the second set of data with the first set of data by the user. Further, the system allows the user to navigate and interact inside the virtual reality representation. The navigation and interaction is allowed for customizing the one or more facility material products associated with the facility.

### TECHNICAL FIELD

The present disclosure relates to a field of virtual reality system. More specifically, the present disclosure relates to a method and system for mapping of products to an architectural design in real-time.

### BACKGROUND

Industries involved in construction of various facilities operate as per a specific blueprint or architectural design of the facility. The blueprint or architectural design is essential in order to construct the facility. Examples of the various facilities include buildings, offices, homes, factories and the like. The construction of these facilities requires selection of construction material based on the design of the blueprint. The blueprint may be designed in a plurality of methods. The methods include a 2-dimensional image, a 2-dimensional model, a 3-dimensional model and the like. Further, interior decoration requires selection of material and color of finishing material by a user. The user needs to visualize design of construction material on the blueprint in mind and customize design in visualizations. However, this does not provide the user with a clear picture of the look and feel of the facility in mind. In addition, the blueprint only provides a rough idea about the architecture of the facility. Also, the blueprint does not provide us with real-time cost estimation and customization of the facility. In addition, the blueprint does not provide us with the ability to view and feel architecture of the facility as if the architecture is already constructed. The blueprint does not allow us to immerse inside architecture of the facility in an interactive way. Sometimes, the facility is not constructed according to requirements of the user even when the facility is constructed based on the blueprint of the facility. This situation occurs because the blueprint does not provide us with a clear understanding about look and feel of the facility in an immersive and interactive way. Also, the blueprint cannot provide real-time cost estimation of construction of the facility in an interactive way. There is a constant need for a system to view and customize blueprint of the facility in an immersive and interactive way in real time.

### SUMMARY

In a first example, a computer-implemented method is provided. The computer-implemented method is configured to perform real-time mapping of products to an architectural design in a virtual reality representation. The method includes a first step of collecting a first set of data associated with one or more facility material products at a facility visualization system. The method includes another step of receiving a second set of data associated with a facility at the facility visualization system. The method includes yet another step of mapping the first set of data associated with the one or more facility material products with the second set of data associated with the facility at the facility visualization system. The method includes yet another step of creating the virtual reality representation of the facility based on the first set of data, the second set of data and mapping of the second set of data with the first set of data at the facility visualization system. The method includes yet another step of allowing a user to navigate inside the virtual reality representation at the facility visualization system. The one or more facility material products are selected by the user from one or more categories displayed on a communication device. The facility material products are displayed on the communication device with one or more properties of the facility material products. The communication device is associated with the user in real time. The second set of data is architectural information of the facility. The second set of data is received from the user in real time through the communication device. The mapping is done to create the virtual reality representation of the facility with the selected one or more facility material products. The virtual reality representation of the facility is created in real time. The navigation is allowed for customizing the one or more facility material products associated with the facility. The customization is done by utilizing one or more shortlist facility material products displayed on a plurality of virtual reality devices in the virtual reality representation. The plurality of virtual reality devices are used for allowing navigation and customization in the virtual reality representation in real time.

In an embodiment of the present disclosure, the one or more categories of the facility material products include basic building, flooring, electrical wiring, electrical fittings, wall finishing, plumbing, sanitary fittings, roofing, kitchen fittings, doors and windows, hardware and paints.

In an embodiment of the present disclosure, the one or more properties of the facility material products include brand, model, size, color, type, finish, weight and dimensions associated with the facility material products.

In an embodiment of the present disclosure, the second set of data is associated with the architectural information of the facility. The architectural information of the facility includes building information modeling documents, blueprint, layout and pattern information associated with the facility.

In an embodiment of the present disclosure, the one or more shortlist facility material products are collected from the first set of data. The one or more shortlist facility material products are collected based on preference of the user. The one or more properties of the one or more shortlist facility material products are displayed in the virtual reality representation for the customization.

In an embodiment of the present disclosure, the plurality of virtual reality devices includes a wearable device and a handheld device. The wearable device provides the virtual reality representation to the user. The handheld device allows the user to navigate and customize the one or more facility inside the virtual reality representation in real time.

In an embodiment of the present disclosure, the facility visualization system recommends the one or more facility material products and one or more layout associated with one or more different facilities. The recommendation is done based on the past user data. The past user data is fetched and analyzed from the database in real time.

In a second example, a computer system is provided. The computer system includes one or more processors and a memory coupled to the one or more processors. The memory stores instructions which, when executed by the one or more processors cause the one or more processors to perform a method. The method is configured to perform real-time mapping of products to an architectural design in a virtual reality representation. The method includes a first step of collecting a first set of data associated with one or more facility material products at a facility visualization system. The method includes another step of receiving a second set of data associated with a facility at the facility visualization system. The method includes yet another step of mapping the first set of data associated with the one or more facility material products with the second set of data associated with the facility at the facility visualization system. The method includes yet another step of creating the virtual reality representation of the facility based on the first set of data, the second set of data and mapping of the second set of data with the first set of data at the facility visualization system. The method includes yet another step of allowing a user to navigate inside the virtual reality representation at the facility visualization system. The one or more facility material products are selected by the user from one or more categories displayed on a communication device. The facility material products are displayed on the communication device with one or more properties of the facility material products. The communication device is associated with the user in real time. The second set of data is architectural information of the facility. The second set of data is received from the user in real time through the communication device. The mapping is done to create the virtual reality representation of the facility with the selected one or more facility material products. The virtual reality representation of the facility is created in real time. The navigation is allowed for customizing the one or more facility material products associated with the facility. The customization is done by utilizing one or more shortlist facility material products displayed on a plurality of virtual reality devices in the virtual reality representation. The plurality of virtual reality devices are used for allowing navigation and customization in the virtual reality representation in real time.

In a third example, a non-transitory computer usable storage memory is provided. The non-transitory computer usable storage memory encodes computer executable instructions that, when executed by at least one processor, performs a method. The method is configured to perform real-time mapping of products to an architectural design in a virtual reality representation. The method includes a first step of collecting a first set of data associated with one or more facility material products at a facility visualization system. The method includes another step of receiving a second set of data associated with a facility at the facility visualization system. The method includes yet another step of mapping the first set of data associated with the one or more facility material products with the second set of data associated with the facility at the facility visualization system. The method includes yet another step of creating the virtual reality representation of the facility based on the first set of data, the second set of data and mapping of the second set of data with the first set of data at the facility visualization system. The method includes yet another step of allowing a user to navigate inside the virtual reality representation at the facility visualization system. The one or more facility material products are selected by the user from one or more categories displayed on a communication device. The facility material products are displayed on the communication device with one or more properties of the facility material products. The communication device is associated with the user in real time. The second set of data is architectural information of the facility. The second set of data is received from the user in real time through the communication device. The mapping is done to create the virtual reality representation of the facility with the selected one or more facility material products. The virtual reality representation of the facility is created in real time. The navigation is allowed for customizing the one or more facility material products associated with the facility. The customization is done by utilizing one or more shortlist facility material products displayed on a plurality of virtual reality devices in the virtual reality representation. The plurality of virtual reality devices are used for allowing navigation and customization in the virtual reality representation in real time.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment of a system to provide real-time mapping of products to an architectural design in virtual reality, in accordance with various embodiments of the present disclosure;

FIG. 2A and FIG. 2B illustrates a flowchart for a method to provide real-time mapping of products to an architectural design in virtual reality, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

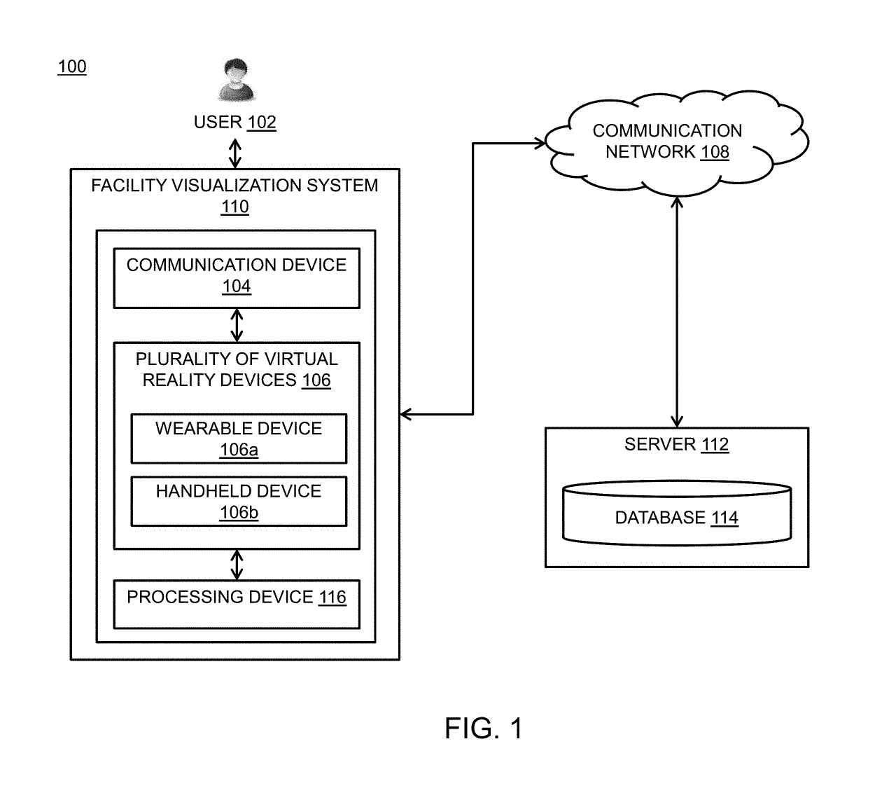

FIG. 1 illustrates a general overview of a system 100 for real-time mapping of products to an architectural design in a virtual reality representation, in accordance with various embodiments of the present disclosure. The system 100 includes a user 102, a communication device 104, a plurality of virtual reality devices 106, a communication network 108, a facility visualization system 110, a server 112, a database 114 and a processing device 116. Further, the plurality of virtual reality devices 106 includes a wearable device 106a and a handheld device 106b. In addition, the architectural design refers to blueprint or layout of a facility. The architectural design may be in the form of a 2-dimensional image, a 2-dimensional model or a 3-dimensional model. The architectural design may be provided by people who can include architect, builder and the like. The architectural design gives us a general idea of framework or layout of the facility.

Also, the facility refers to architecture or building which is to be constructed by an architect. The facility refers to the architecture or building which is constructed based on the architectural design provided. Also, the term products here refer to facility material products. The facility material products refer to a wide collection of products which are required for interior and outer decoration and usage of the facility. The facility material products include but may not be limited to different varieties of tiles, paints, furniture, electrical wiring, electrical fittings, and veneer. In general, virtual reality refers to computer technology which uses tools to generate realistic images, sounds, and other sensations. Further, the sensation simulates a person's physical presence in a virtual or imaginary environment. The tools include but may not be limited to virtual reality headsets or multi-projected environments. The person using virtual reality equipment is able to look around the artificial world. The person may also feel the artificial world with high-quality VR and move around in it and interact with virtual items. The effect is commonly created by VR headset. The VR headset consists a head-mounted display with a small screen in front of the eyes. The virtual environment may also be created through specially designed rooms with multiple large screens. The term virtual environment here refers to a world or environment which does not exist in reality but may be seen or felt virtually through virtual reality devices. Also, the term VR here refers to virtual reality.

The system 100 includes the communication device 104. The communication device 104 is associated with the user 102. The user 102 is a person who wants to map the facility material products to the facility in real time. In addition, the user 102 is the person who wants to have a cost estimation analysis of the project/facility based on the selection of the material products in real time. In an example, the user 102 includes architect, builder, end customer and the like. The communication device 104 is a device which mainly comprises network connectivity. In an embodiment of the present disclosure, the communication device 104 is compatible with the virtual reality representation. In addition, the communication device 104 provides an interface to the user 102 to create a new project for the facility. The term new project here refers to details about the facility. The details include but may not be limited to name and location of the project. In addition, the details include mobile number, e-mail address of the user 102 and the like.

In an example, the communication device 104 prompts a login page for the verification of the authenticity of the user 102. The user 102 enters the e-mail id and password to login using the communication device 104. Further, the communication device 104 collects information about the project from the user 102 every time the communication device 104 creates a new project. In an example, the information includes project name, location of project, pin code of location of the project and the like. In an example, the communication device 104 includes laptop, desktop, portable mobile device and the like. In addition, the portable mobile device includes sensors to track orientation and movement of the portable mobile device. The sensors include but may not be limited to a gyroscope.

The system 100 includes the plurality of virtual reality devices 106. In an embodiment of the present disclosure, the communication device 104 is connected with the plurality of virtual reality devices 106. Further, the plurality of virtual reality devices 106 includes a plurality of devices which provide virtual reality experience to the user 102. The plurality of virtual reality devices 106 are connected by the processing device 116. The processing device 116 provides power to the plurality of virtual reality devices 106 to operate. The plurality of virtual reality devices 106 may or may not be powered by a processing device. In an embodiment of the present disclosure, the virtual reality devices may work independently without the need to be powered by a processing device.

In addition, the plurality of virtual reality devices 106 includes the wearable device 106a and the handheld device 106b. However, the plurality of virtual reality devices 106 are not limited to specified devices. In an embodiment of the present disclosure, the plurality of virtual reality devices 106 includes a plurality of devices which are capable to provide virtual reality experience to the user 102. In an embodiment of the present disclosure, the plurality of virtual reality devices 106 may include a plurality of the wearable device 106a and a plurality of the handheld device 106b. In another embodiment of the present disclosure, the plurality of virtual reality devices 106 may include either the plurality of the wearable device 106a or the plurality of the handheld device 106b.

In an embodiment of the present disclosure, the wearable device 106a is a device which is worn around the eyes of the user 102. The wearable device 106a covers eyes of the user 102 completely to display an artificial environment. The user 102 feels to be completely immersed in the virtual reality representation through the wearable device 106a. Also, the wearable device 106a may or may not provide rich sound experience to the user 102. The user 102 indulges into the artificial environment created by the virtual reality representation using the wearable device 106a. The wearable device 106a includes but may not be limited to head-mounted display. In an example, the wearable device 106a is head-mounted display device. Further, the wearable device 106a allows the user 102 to experience virtual reality in real time. In an example, the head-mounted display device is worn around the eyes of the user 102 similar to binoculars. In an example, the head-mounted display device includes but may not be limited to Google Cardboard and HTC Vive.

In addition, the plurality of virtual reality devices 106 includes the handheld device 106b. In an embodiment of the present disclosure, the handheld device 106b is worn around hand of the user 102. In another embodiment of the present disclosure, the handheld device 106b is held in hands of the user 102 like a remote. The handheld device 106b is used by the user 102 to control and navigate around the virtual reality representation. The user 102 controls and moves the handheld device 106b to navigate around the virtual reality representation. The navigation may be made using specific buttons embedded inside the handheld device 106b.

In an embodiment of the present disclosure, the handheld device 106b includes a plurality of sensors along with buttons. The handheld device 106b projects a beam using gestures in the virtual reality representation. The projected beam helps the user 102 to select different options and navigate around in the virtual reality representation. In an embodiment of the present disclosure, the plurality of virtual reality devices 106 may include a data glove. In general, the data glove is an interactive device which resembles a glove worn on the hand. Further, the data glove facilitates tactile sensing and fine-motion control in robotics and virtual reality. Also, the data glove is one of several types of electromechanical devices used in haptic applications. The data glove senses objects present in the virtual reality representation. The data glove includes the plurality of sensors to provide rich and enhanced virtual reality representation to the user 102. The user 102 senses and feels any object present in the virtual reality representation as if it is present in reality using the data glove.

In an example, the user 102 wears the data glove inside the virtual reality representation. The user 102 is able to feel the objects present in the virtual reality representation as if the objects are present in reality. Although the objects are not present in reality but only can be seen virtually. Suppose, the user 102 views tiles in front of the eyes in the virtual reality representation. The user 102 may feel the texture and quality of the tile using the data glove in the virtual reality representation.

In an embodiment of the present disclosure, the wearable device 106a is connected with the handheld device 106b. The wearable device 106a is connected wirelessly with the handheld device 106b. In another embodiment of the present disclosure, the wearable device 106a is connected using a wired connection with the handheld device 106b.

Further, the system 100 includes the communication network 108. The communication network 108 is used to provide network connectivity to the communication device 104. The communication network 108 provides network connectivity to the communication device 104 in a plurality of methods. The plurality of methods includes 2G, 3G, 4G, Wi-Fi and the like. In an embodiment of the present disclosure, the communication network 108 provides connectivity options to the communication device 104 in geographical areas having lower connectivity. The communication network 108 uses light-weight protocol versions to provide seamless connectivity to the communication device 104 even in geographical areas having lower connectivity.

In addition, the communication network 108 is connected to the plurality of virtual reality devices 106. The communication network 108 provides network connectivity to the plurality of virtual reality devices 106. The communication network 108 connects the plurality of virtual reality devices 106 with each other and with internet. The communication network 108 provides seamless connectivity to the plurality of virtual reality devices 106.

The system 100 includes the facility visualization system 110. The facility visualization system 110 is connected with the communication device 104 and the plurality of virtual reality devices 106 using the communication network 108. The facility visualization system 110 provides the facility material products for selection to the user 102. The user 102 is provided access to choose from the facility material products using the communication device 104. In addition, the facility visualization system 110 is responsible to perform computing operations to map the architectural design of the facility with the one or more facility material products selected by the user 102. Further, the facility visualization system 110 transforms the architectural design with one or more categories of the facility material products into the virtual reality representation. Also, the facility visualization system 110 displays the virtual reality representation to the user 102 using the plurality of virtual reality devices 106.

In an embodiment of the present disclosure, the facility visualization system 110 displays the facility material products on the communication device 104. The facility visualization system 110 displays the facility material products for selection by the user 102. The facility material products include the one or more categories of the facility material products.

In an embodiment of the present disclosure, the one or more categories of the facility material products comprise wall units, furniture, basic building, flooring, electrical wiring, electrical fittings, wall finishing, plumbing, sanitary fittings, roofing, kitchen fittings, doors and windows, hardware, paints and the like.

Further, the one or more categories of the facility material products include the one or more properties of the facility material products. The one or more properties of the facility material products include category, brand, model, product type, finish, color, budget class, target suitability, product design and the like. However, the one or more properties of the facility material products are not limited to above mentioned properties. In an example, the category include but may not be limited to tiles, paints, veneer, wash basins, toilets and the like. In addition, product type includes selection between vitrified or ceramic for tiles, selection between mount type for the toilets and the like. In an example, the mount type includes wall hung mount, floor mount and the like. The finish includes selection between matt finish, glossy finish and the like. Further, the budget class includes normal, premium, luxury and the like.

In an embodiment of the present disclosure, the target suitability includes space type, surface type, room type and the like. In an example, the space type includes interior, exterior and the like. The space type includes area where product is applied in the virtual reality representation. The surface type includes wall, floor, cabinet and the like. The surface type provides details about surface area where product is applied in the virtual reality representation. The room type includes bathroom, kitchen and the like. The room type includes area of room where product is applied in the virtual reality representation. The product design includes 2D image, 3D model and the like. The product design allows the user 102 to watch 2D image or 3D model of the facility material products.

In an example, the facility material products provide complete range of products which may be utilized during construction of the facility. The facility material products even include selection of different types of rooms to choose from. The facility material products used in bathroom are different from the facility material products used in kitchen. The facility material products used in bathroom include taps, tiles, mounts and the like. The facility material products used in living room include tiles, carpets, paints, electrical wiring and the like.

In an example, the facility visualization system 110 displays facility material products from different brands. The brands may include Kirloskar, Kajaria and the like. The facility visualization system 110 displays a wide range of colour options available for selection of the facility material products.

The facility visualization system 110 collects a first set of data associated with one or more facility material products. The one or more facility material products are selected by the user 102 from the one or more categories of the facility material products displayed on the communication device 104. The facility material products are displayed on the communication device 104 with one or more properties of the facility material products. The communication device 104 is associated with the user 102. The first set of data is sent through the communication network 108. In an example, the user 102 selects the one or more categories of the facility material products. The user 102 selects the one or more facility material products from the one or more categories of the facility material products which are to be included in the facility. The user 102 selects the one or more categories of the facility material products based on user preference.

The facility visualization system 110 receives a second set of data associated with the facility. The second set of data is associated with architectural information of the facility. The second set of data is received from the user 102 through the communication device 104. The architectural information of the facility includes building information modeling documents, architectural blueprint, layout of the facility and the like. In addition, the building information includes space type, surface type, room type and the like. The specific user preferences include brand, model, product type, color, finish, design pattern and the like. In an example, the design pattern includes but may not be limited to design for laying pattern for tiles. In an example, the user 102 may provide information about the different rooms the user 102 wants to have in the facility. The user 102 may provide specific information about the different surfaces and floors of the facility. In an embodiment of the present disclosure, the second set of data includes the building information modeling documents of the facility. However, the second set of data is not limited to the above mentioned documents. The facility visualization system 110 accepts the building information modeling documents from the user 102. In an example, the facility visualization system 110 collects the first set of data and the second set of data by the user 102 using the communication device 104.

Further, the facility visualization system 110 maps the first set of data associated with the one or more facility material products with the second set of data associated with the facility. The facility visualization system 110 maps the first set of data with the second set of data to create the virtual reality representation of the facility with the selected one or more facility material products. In an embodiment of the present disclosure, the facility visualization system 110 maps the first set of data with the second set of data based on one or more options. The one or more options include but may not be limited to user preference, selection of the one or more categories of the facility material products and properties of the facility material products.

In an embodiment of the present disclosure, the user 102 creates the virtual reality representation of the facility at the facility visualization system 110. The facility visualization system 110 creates the virtual reality representation based on the first set of data, the second set of data and mapping of the second set of data with the first set of data. The facility visualization system 110 creates the virtual reality representation of the facility. In another embodiment of the present disclosure, the facility visualization system 110 may automatically create the virtual reality representation of the facility in real time. In an embodiment of the present disclosure, the facility visualization system 110 uses the building information modeling documents to create the virtual reality representation of the facility. The facility visualization system 110 displays cost of the plurality of products in the virtual reality representation of the facility.

In an embodiment of the present disclosure, the user 102 uses the plurality of the virtual reality devices 106 to view the virtual reality representation of the facility. The facility visualization system 110 maps the first set of data with the second set of data to create the virtual reality representation of the facility. Also, the plurality of virtual reality devices 106 are required to view the facility in virtual reality. Also, the plurality of virtual reality devices 106 are powered by the processing device 116. The user 102 wears the wearable device 106a to view the facility in virtual reality. The facility visualization system 110 displays cost of the one or more facility material products in real time.

In an embodiment of the present disclosure, the facility visualization system 110 displays one or more shortlist facility material products. Also, the facility visualization system 110 displays cost of the one or more shortlist facility material products. The user 102 is allowed to choose from the one or more shortlist facility material products in real time in the virtual reality representation. The facility visualization system 110 is connected with the communication network 108 for synchronous connectivity in the virtual reality representation. The facility visualization system 110 provides budget monitoring and cost estimate of the one or more shortlist facility material products in real time.

In an embodiment of the present disclosure, the facility visualization system 110 allows the user 102 to choose products from the one or more categories of the facility material products. The chosen products are termed here as the one or more shortlist facility material products. The one or more shortlist facility material products are displayed to user 102 for selection in the virtual reality representation. The user 102 is allowed to try the one or more shortlist facility material products in real-time to select appropriate product according to requirement of the user 102. In another embodiment of the present disclosure, the facility visualization system 110 recommends the one or more shortlist facility material products to the user 102 using hardware run machine learning algorithm. The facility visualization system 110 adapts to the behavior of the user 102. Further, the facility visualization system 110 recommends the one or more shortlist facility material products to the user 102.

The facility visualization system 110 allows the user 102 to navigate and interact inside the virtual reality representation. The user 102 is allowed to navigate and interact for customizing the one or more facility material products associated with the facility. The customization is done by utilizing the one or more shortlist facility material products displayed on the plurality of virtual reality devices 106 in the virtual reality representation. The plurality of virtual reality devices 106 are used for allowing interaction, navigation and customization in the virtual reality representation in real-time. The user 102 navigates and interacts inside the virtual reality representation of the facility in real time. The facility visualization system 110 allows the user 102 to navigate and interact inside the virtual reality representation using the plurality of the handheld device 106b. The user 102 holds the handheld device 106b in hand and selects the one or more facility material products using the handheld device 106b. The handheld device 106b is used to navigate inside the virtual reality representation. The handheld device 106b is used to make selections inside the virtual reality representation. In an embodiment of the present disclosure, the facility visualization system 110 displays budget model and cost estimation of the project according to the one or more shortlist facility material products selected. In an example, the one or more facility material products are displayed in the virtual reality representation. The user 102 uses the handheld device 106b to select the one or more shortlist facility material products from the one or more facility material products. The cost of the one or more shortlist facility material products is displayed in the virtual reality representation. The facility visualization system 110 provides cost estimation model of the one or more facility material products based on the selection of the one or more shortlist material facility products in real time.

In an embodiment of the present disclosure, the one or more shortlist facility material products are collected from the first set of data. The one or more shortlist facility material products are collected based on preference of the user. In an embodiment of the present disclosure, the one or more properties of the one or more shortlist facility material products are displayed in the virtual reality representation for customization. In an example, the user 102 selects the one or more shortlist facility material products from the first set of data. The user 102 selects the one or more shortlist facility material products based on preference of the user 102. Further, the facility visualization system 110 projects the one or more shortlist facility material products in the virtual reality representation for customization in real time.

In an embodiment of the present disclosure, the facility visualization system 110 displays the one or more shortlist facility material products on the communication device 104. Also, the facility visualization system 110 provides information of cost of the one or more shortlist facility material products which are displayed on the portable communication device 104. The cost of the one or more shortlist facility material products is updated as the user 102 watch representation of the facility using the communication device 104. In another embodiment of the present disclosure, the facility visualization system 110 updates cost of the one or more shortlist facility material products when the handheld device 106b is pointed towards the one or more facility in the virtual reality representation.

In an embodiment of the present disclosure, the user 102 is present inside a CAVE environment. CAVE stands for CAVE automatic virtual environment. In general, CAVE is an immersive virtual reality environment where projectors are directed to between three and six of the walls of a room-sized cube. A room is converted into a virtual reality environment. In an embodiment of the present disclosure, the user 102 is present in CAVE environment. The user 102 experiences the virtual reality representation wearing the wearable device 106a and a specially designed room in real time. In an example, the user 102 is wearing the wearable device 106a and the data glove inside the CAVE environment. The user 102 feels to be immersed inside the CAVE environment. The user 102 feels to be present inside the architectural design of the facility with the facility material products. The user 102 is allowed to feel the facility material products using the data glove.

Further, the facility visualization system 110 is connected with the server 112. The server 112 includes the database 114. In general, the server 112 is a computer, device or a program which is dedicated to managing network resources. The server 112 manages all the operations performed by the facility visualization system 110.

The database 114 is storage location of the facility visualization system 110. The database 114 stores the one or more categories of the facility material products. The database 114 provides storage to the facility material products. The database 114 stores the one or more shortlist facility material products and the one or more properties of the facility material products. In addition, the database 114 stores the second set of data which include building information modeling documents, architectural design, layout and the like. Also, the database 114 stores the virtual reality representation data in the memory of the database 114. The database 114 provides storage location to complete data of the facility visualization system 110. The database 114 is secured with high-level security algorithms.

Further, the facility visualization system 110 connects the user 102 to e-commerce sites. In an embodiment of the present disclosure, the facility visualization system 110 connects the user 102 to e-commerce sites using a payment gateway. The payment gateway is secured using high-level secured algorithms. The facility visualization system allows the user 102 to select the facility material products in real-time. The user 102 is allowed to make secured payment through the virtual reality representation in real time. In an example, the facility visualization system 110 displays the one or more shortlist facility material products in real time. The user 102 makes selection of the facility material products from the one or more shortlist facility material products which are required. Further, the facility visualization system 110 connects the user 102 to the secured gateway to connect to e-commerce sites. The user 102 completes the payment using the secured gateway.

In an embodiment of the present disclosure, the facility visualization system 110 recommends the one or more facility material products. Also, the facility visualization system 110 recommends one or more layout associated with one or more different facilities. The recommendation is done based on the past user data. The past user data is fetched and analyzed from the database 114 in real time. In an example, the facility visualization system 110 stores past user data in the database 114. The facility visualization system 110 recommends the one or more layout which is associated with the one or more different facilities. The recommendation is done based on the past user data.

In an embodiment of the present disclosure, the facility visualization system 110 performs real-time mapping of the one or more shortlist facility material products to an architectural design in mixed reality representation. In general, mixed reality (sometimes referred to as hybrid reality) is merging of real and virtual worlds to produce new environments and visualizations where physical and digital objects co-exist and interact in real time. Also, mixed reality takes place not only in the physical world or the virtual world, but is a mix of reality and virtual reality, encompassing both augmented reality and augmented virtuality via immersive technology.

In an embodiment of the present disclosure, the user 102 views the one or more shortlist facility material products on the architectural design in mixed reality representation using mixed reality device. In another embodiment of the present disclosure, the user 102 views the one or more shortlist facility material products on the architectural design in mixed reality representation using a plurality of mixed reality devices. The plurality of devices used to display mixed reality representation include Microsoft Hololens, Meta 2, Smart Glasses like Google glass and the like.

In an example, the user 102 wears mixed reality device at his home. Further, the user 102 connects mixed reality device with the facility visualization system 110 and launches mixed reality supported application on the communication device 104. Further, the user 102 selects the one or more facility material products to display in mixed reality representation. The user 102 may decide where to place the product, and select from different brands, models and color options. In an embodiment of the present disclosure, the user 102 may combine the plurality of virtual reality devices 106 along with mixed reality devices. The mixed reality representation is created in real-time along with information such as cost estimate of the one or more products.

In an embodiment of the present disclosure, the facility visualization system 110 performs real-time mapping of the one or more facility material products to an architectural design in augmented reality representation. In general, augmented reality (AR) is live direct or indirect view of a physical, real-world environment whose elements are augmented by computer-generated perceptual information, ideally across multiple sensory modalities, including visual, auditory, haptic, somatosensory, and olfactory. In general, augmented reality alters one's current perception of a real world environment, whereas virtual reality replaces the real world environment with a simulated one.

In an embodiment of the present disclosure, the user 102 views the facility material products on the architectural design in augmented reality representation using augmented reality supported device. In another embodiment of the present disclosure, the user 102 views the one or more facility material products on the architectural design in augmented reality representation using a plurality of augmented reality supported devices. The plurality of augmented reality supported devices used to display augmented reality representation include Microsoft Hololens, Lightwear by Magic Leap, augmented reality-driven smartphones and the like. In an example, the augmented reality-driven smartphones are based on technologies such as ARKit, ARCore and the like.

In an example, the user 102 uses augmented reality supported device. Further, the user 102 connects augmented reality device with the facility visualization system 110 and launches augmented reality supported application on the communication device 104. Further, the user 102 selects the one or more facility products to display in augmented reality representation. The user 102 may decide where to place the product, and select from different brands, models and color options. In an embodiment of the present disclosure, the user 102 may combine the plurality of virtual reality devices 106 along with augmented reality devices. The augmented reality representation is created in real-time along with information such as cost estimate of the one or more products.

In an embodiment of the present disclosure, the user 102 interacts, navigates and customizes the virtual reality representation using hand gestures and audio commands. In another embodiment of the present disclosure, the user 102 interacts, navigates and customizes mixed reality representation using hand gestures and audio commands. In yet another embodiment of the present disclosure, the user 102 interacts, navigates and customizes augmented reality representation using hand gestures and audio commands. In an example, hand gestures include gestures such as tapping in air by the user 102, waving hand in air by the user 102 and the like. In an example, audio commands include commands such as saying “give me the first option” for selecting and applying first tile or paint color shown in the menu and the like. However, hand gestures and audio commands are not limited to above mentioned gestures and commands.

In an embodiment of the present disclosure, the facility visualization system 110 displays budget model and cost estimation of the project according to the one or more shortlist facility material products selected in the virtual reality representation. In another embodiment of the present disclosure, the facility visualization system 110 displays budget model and cost estimation of the project according to the one or more shortlist facility material products selected in mixed reality representation. In yet another embodiment of the present disclosure, the facility visualization system 110 displays budget model and cost estimation of the project according to the one or more shortlist facility material products selected in augmented reality representation.

In an example, the user 102 selects a certain Vitrified Tile product for living area. The facility visualization system 110 uses building information such as area per tile, tiles per box and project or building to calculate cost estimation of the project/facility based on the selection of the material products in real time. Also, the facility visualization system 110 uses product information such as area of living room floor to calculate number of boxes of the product to order in real-time. The facility visualization system 110 predicts cost estimation of the project/facility based on the selection of the material products in real time.

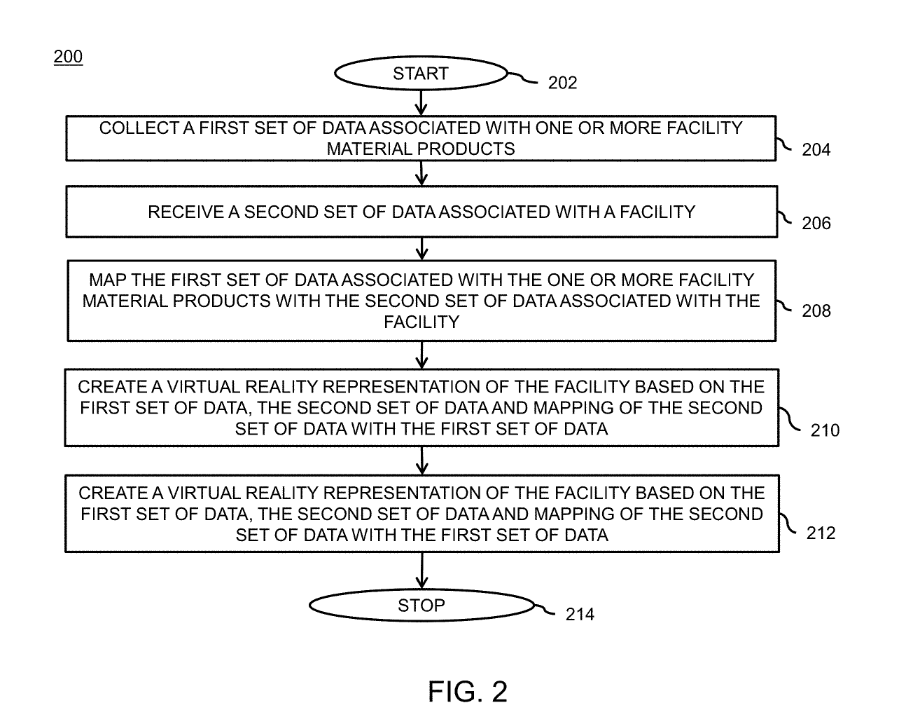

FIG. 2 illustrates a flowchart 200 for a method for the real-time mapping of the products to the architectural design in the virtual reality representation, in accordance with various embodiments of the present disclosure. It may be noted that to explain the process steps of the flowchart 200, references will be made to the system elements of FIG. 1. It may be noted that the flowchart 200 may have lesser or more number of steps.

The flowchart 200 initiates at step 202. Following step 202, at step 204, the facility visualization system 110 collects the first set of data associated with the one or more facility material products. The one or more facility material products are selected by the user from one or more categories of the facility material products displayed on a communication device. At step 206, the facility visualization system 110 receives the second set of data associated with a facility, wherein the second set of data is architectural information of the facility. At step 208, the facility visualization system 110 maps the first set of data associated with the one or more facility material products with the second set of data associated with the facility. The mapping is done to create the virtual reality representation of the facility with the selected one or more facility material products. At step 210, the facility visualization system 110 creates the virtual reality representation of the facility based on the first set of data, the second set of data and mapping of the second set of data with the first set of data. At step 212, the facility visualization system 110 allows the user to navigate inside the virtual reality representation. The navigation is allowed for customizing the one or more facility material products associated with the facility. The customization is done by utilizing one or more select facility material products displayed on a plurality of virtual reality devices in the virtual reality representation. The plurality of virtual reality devices is powered by a processing device. The plurality of virtual reality devices is used for allowing interaction, navigation and customization in the virtual reality representation in real-time. The flow chart 200 terminates at step 214.

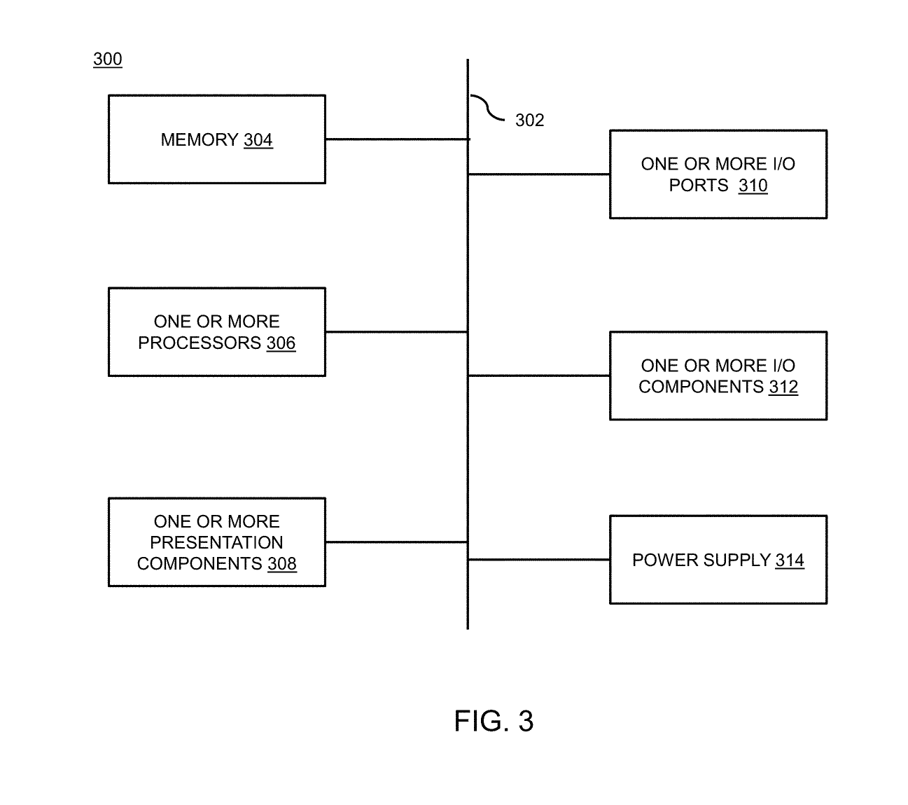

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312 and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A computer-implemented method for real-time mapping of products to an architectural design in a virtual reality representation, the computer-implemented method comprising:
collecting, at a facility visualization system with a processor, a first set of data associated with one or more facility material products, wherein the one or more facility material products is selected by a user from one or more categories of the one or more facility material products displayed on a communication device, wherein the one or more facility material products is displayed on the communication device with one or more properties of the one or more facility material products, wherein the communication device is associated with the user;
receiving, at the facility visualization system with the processor, a second set of data associated with a facility, wherein the second set of data is architectural information of the facility, wherein the second set of data is received from the user through the communication device;
mapping, at the facility visualization system with the processor, the first set of data associated with the one or more facility material products with the second set of data associated with the facility, wherein the mapping is done to create a virtual reality representation of the facility with the selected one or more facility material products;
creating, at the facility visualization system with the processor, the virtual reality representation of the facility based on the first set of data, the second set of data and mapping of the second set of data with the first set of data, wherein the virtual reality representation of the facility is created by the user; and
allowing, at the facility visualization system with the processor, the user to navigate inside the virtual reality representation, wherein the navigation is allowed for customizing the one or more facility material products associated with the facility, wherein the customization is done by utilizing one or more select facility material products displayed on a plurality of virtual reality devices in the virtual reality representation, wherein the plurality of virtual reality devices is powered by a processing device, wherein the plurality of virtual reality devices is used for allowing interaction, navigation and customization in the virtual reality representation in real-time.

2. The computer-implemented method as claimed in claim 1, wherein the one or more categories of the facility material products comprises wall units, furniture, basic building, flooring, electrical wiring, electrical fittings, wall finishing, plumbing, sanitary fittings, roofing, kitchen fittings, doors and windows, hardware and paints.

3. The computer-implemented method as claimed in claim 1, wherein the one or more properties of the facility material products comprises brand, model, size, colour, type, finish, weight and dimensions associated with the facility material products.

4. The computer-implemented method as claimed in claim 1, wherein the second set of data is associated with the architectural information of the facility, wherein the architectural information of the facility comprises building information modeling documents, blueprint, layout and pattern information associated with the facility.

5. The computer-implemented method as claimed in claim 1, wherein the one or more shortlist facility material products is collected from the first set of data, wherein the one or more shortlist facility material products is collected based on preference of the user, wherein the one or more properties of the one or more shortlist facility material products is displayed in the virtual reality representation for the customization.

6. The computer-implemented method as claimed in claim 1, wherein the plurality of virtual reality devices comprise a wearable device and a handheld device, wherein the wearable device provides the virtual reality representation to the user, wherein the handheld device allows the user to interact, navigate and customize the one or more facility inside the virtual reality representation in real time.

7. The computer-implemented method as claimed in claim 1, wherein the facility visualization system recommends the one or more facility material products and one or more layout associated with one or more different facilities, wherein the recommendation is done based on the past user data, wherein the past user data is fetched and analyzed from the database in real time.

8. A computer system comprising:
one or more processors; and
a memory coupled to the one or more processors, the memory for storing instructions which, when executed by the one or more processors, cause the one or more processors to perform a method for real-time mapping of products to an architectural design in a virtual reality representation, the method comprising:
collecting, at a facility visualization system, a first set of data associated with one or more facility material products, wherein the one or more facility material products is selected by a user from one or more categories of the one or more facility material products displayed on a communication device, wherein the one or more facility material products is displayed on the communication device with one or more properties of the one or more facility material products, wherein the communication device is associated with the user;
receiving, at the facility visualization system, a second set of data associated with a facility, wherein the second set of data is architectural information of the facility, wherein the second set of data is received from the user through the communication device;
mapping, at the facility visualization system, the first set of data associated with the one or more facility material products with the second set of data associated with the facility, wherein the mapping is done to create a virtual reality representation of the facility with the selected one or more facility material products;
creating, at the facility visualization system, the virtual reality representation of the facility based on the first set of data, the second set of data and mapping of the second set of data with the first set of data, wherein the virtual reality representation of the facility is created by the user; and
allowing, at the facility visualization system, the user to navigate inside the virtual reality representation, wherein the navigation is allowed for customizing the one or more facility material products associated with the facility, wherein the customization is done by utilizing one or more select facility material products displayed on a plurality of virtual reality devices in the virtual reality representation, wherein the plurality of virtual reality devices is powered by a processing device, wherein the plurality of virtual reality devices is used for allowing interaction, navigation and customization in the virtual reality representation in real-time.

9. The computer system as claimed in claim 8, wherein the one or more categories of the facility material products comprises wall units, furniture, basic building, flooring, electrical wiring, electrical fittings, wall finishing, plumbing, sanitary fittings, roofing, kitchen fittings, doors and windows, hardware and paints.

10. The computer system as claimed in claim 8, wherein the one or more properties of the facility material products comprises brand, model, size, colour, type, finish, weight and dimensions associated with the facility material products.

11. The computer system as claimed in claim 8, wherein the second set of data is associated with the architectural information of the facility, wherein the architectural information of the facility comprises building information modeling documents, blueprint, layout and pattern information associated with the facility.

12. The computer system as claimed in claim 8, wherein the one or more shortlist facility material products is collected from the first set of data, wherein the one or more shortlist facility material products is collected based on preference of the user, wherein the one or more properties of the one or more shortlist facility material products is displayed in the virtual reality representation for the customization.

13. The computer system as claimed in claim 8, wherein the plurality of virtual reality devices comprise a wearable device and a handheld device, wherein the wearable device provides the virtual reality representation to the user, wherein the handheld device allows the user to interact, navigate and customize the one or more facility inside the virtual reality representation in real time.

14. The computer system as claimed in claim 8, wherein the facility visualization system recommends the one or more facility material products and one or more layout associated with one or more different facilities, wherein the recommendation is done based on the past user data, wherein the past user data is fetched and analyzed from the database in real time.

15. A non-transitory computer usable storage memory encoding computer executable instructions that, when executed by at least one processor, performs a method for real-time mapping of products to an architectural design in a virtual reality representation, the method comprising:
collecting, at a computing device, a first set of data associated with one or more facility material products, wherein the one or more facility material products is selected by a user from one or more categories of the one or more facility material products displayed on a communication device, wherein the one or more facility material products is displayed on the communication device with one or more properties of the one or more facility material products, wherein the communication device is associated with the user;
receiving, at the computing device, a second set of data associated with a facility, wherein the second set of data is architectural information of the facility, wherein the second set of data is received from the user through the communication device;
mapping, at the computing device, the first set of data associated with the one or more facility material products with the second set of data associated with the facility, wherein the mapping is done to create a virtual reality representation of the facility with the selected one or more facility material products;
creating, at the computing device, the virtual reality representation of the facility based on the first set of data, the second set of data and mapping of the second set of data with the first set of data, wherein the virtual reality representation of the facility is created by the user; and
allowing, at the computing device, the user to navigate inside the virtual reality representation, wherein the navigation is allowed for customizing the one or more facility material products associated with the facility, wherein the customization is done by utilizing one or more select facility material products displayed on a plurality of virtual reality devices in the virtual reality representation, wherein the plurality of virtual reality devices is powered by a processing device, wherein the plurality of virtual reality devices is used for allowing interaction, navigation and customization in the virtual reality representation in real-time.

16. The non-transitory computer usable storage memory as claimed in claim 15, wherein the one or more categories of the facility material products comprises wall units, furniture, basic building, flooring, electrical wiring, electrical fittings, wall finishing, plumbing, sanitary fittings, roofing, kitchen fittings, doors and windows, hardware and paints.

17. The non-transitory computer usable storage memory as claimed in claim 15, wherein the one or more properties of the facility material products comprises brand, model, size, colour, type, finish, weight and dimensions associated with the facility material products.

18. The non-transitory computer usable storage memory as claimed in claim 15, wherein the second set of data is associated with the architectural information of the facility, wherein the architectural information of the facility comprises building information modeling documents, blueprint, layout and pattern information associated with the facility.

19. The non-transitory computer usable storage memory as claimed in claim 15, wherein the one or more shortlist facility material products is collected from the first set of data, wherein the one or more shortlist facility material products is collected based on preference of the user, wherein the one or more properties of the one or more shortlist facility material products is displayed in the virtual reality representation for the customization.

20. The non-transitory computer usable storage memory as claimed in claim 15, wherein the plurality of virtual reality devices comprise a wearable device and a handheld device, wherein the wearable device provides the virtual reality representation to the user, wherein the handheld device allows the user to interact, navigate and customize the one or more facility inside the virtual reality representation in real time.
